(19) United States
(12) Patent Application Publication
(10) Pub. No.: US 2025/0119022 A1
(43) Pub. Date: Apr. 10, 2025

(54) ELECTRIC MACHINE FLUID COOLING SYSTEM WITH AIR VENT

(71) Applicant: Dana Automotive Systems Group, LLC, Maumee, OH (US)

(72) Inventors: Steven VANHEE, Hooglede (BE); Jaywant S. PAWAR, Pune (IN); Maarten DEBROUWERE, Zedelgem (BE); Sam LEROY, Gent (BE)

(21) Appl. No.: 18/908,434

(22) Filed: Oct. 7, 2024

Related U.S. Application Data
(60) Provisional application No. 63/589,235, filed on Oct. 10, 2023.

(51) Int. Cl. H02K 5/20

(52) U.S. Cl. CPC H02K 5/207; H02K 2205/09

(57) ABSTRACT

Methods and systems are provided to cool an electric machine rotor. The electric machine fluid cooling system includes, in one example, one or more air vents in fluidic communication with one or more radial cooling passages of a rotor shaft. In the system, the radial cooling passages are in fluidic communication with one or more rotor shaft cooling passages that extend through the rotor shaft and an inlet cooling passage.

### CROSS REFERENCE TO RELATED APPLICATION

The present application claims priority to U.S. Provisional Application No. 63/589,235, entitled “ELECTRIC MACHINE FLUID COOLING SYSTEM WITH AIR VENT”, and filed on Oct. 10, 2023. The entire contents of the above-listed application are hereby incorporated by reference for all purposes.

### TECHNICAL FIELD

The present disclosure relates to an electric machine with a fluid cooling system that includes an air vent in a rotor shaft.

### BACKGROUND AND SUMMARY

Electric machines, such as electric motors, are used in vehicle powertrains and other systems to provide mechanical power to desired components. To increase electric motor efficiency and continuous performance in vehicle drive units and other systems, motors have made use of cooling systems that direct pressurized oil through channels in the rotor assembly. Cooling the rotor allows the motor's efficiency to be increased. Cooling systems may be particularly desirable in higher performance electric motors with comparatively high efficiency targets.

However, the inventors have recognized several issues with previous motor cooling assemblies. For instance, air may become trapped in certain areas of the rotor shaft cooling assembly. The trapped air may lead to unbalanced centrifugal pressure and therefore increase the pressure drop over a rotor shaft, particularly at higher shaft speeds. To elaborate, in some fluid cooling systems, air may become trapped in passages on an inlet side of the system, which increases pumping power demands in the fluid supply system (e.g., oil supply system). For instance, the air may be introduced into the system during fluid filling. Further, if a mixture of air and oil flows though the rotor, the rotor hydraulic performance and cooling capability may additionally be decreased.

The issues mentioned above may be addressed by a shaft cooling system. The fluid cooling system includes, in one example, an air vent in fluidic communication with a radial cooling passage. In the fluid cooling system, the radial cooling passage is in fluidic communication with a rotor shaft cooling passage that extends through a rotor shaft. Further, in the fluid cooling system, the radial cooling passage is in fluidic communication with an inlet cooling passage that extends through a rotor shaft. In this way, the air trapped in the fluid cooling system can be evacuated, thereby increasing electric machine and cooling system performance.

Further in one example, the air vent may be in fluidic communication with a cavity that is positioned radially inward from a rotor shaft bearing. In this way, the working fluid (e.g., oil) which may be mixed with the air may be directed to the bearing for additional lubrication. For instance, the cooling system may further include a bearing nozzle that extends from the cavity to a bearing cavity that is axially adjacent to the rotor shaft bearing. In this way, the lubricant which is mixed with the air which is removed from the radial cooling passage is directed to the rotor shaft bearing to increase bearing lubrication. Consequently, electric machine efficiency is further increased.

It should be understood that the summary above is provided to introduce in a simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a perspective view of an electric machine with a fluid cooling system.

FIG. 2 shows a detailed perspective view of the fluid cooling system in the electric machine rotor shaft depicted in FIG. 1.

FIG. 3 shows a cross-sectional view of the electric machine rotor shaft depicted in FIG. 1 according to a first embodiment of the present disclosure.

FIG. 4A shows a first position of a nozzle plug of the fluid cooling system according to the first embodiment of the present disclosure.

FIG. 4B shows a second position of the nozzle plug of the fluid cooling system according to the first embodiment of the present disclosure.

FIG. 5 shows an exemplary computational fluid dynamics model of working fluid and air in the fluid cooling system according to the first embodiment of the present disclosure.

FIG. 6 shows a cross-sectional view of the electric machine rotor shaft depicted in FIG. 1 according to a second embodiment of the present disclosure.

FIG. 7 shows a cross-sectional view of the electric machine rotor shaft depicted in FIG. 1 according to a third embodiment of the present disclosure.

FIG. 8 shows an exemplary computational fluid dynamics model of working fluid and air in the fluid cooling system according to the second embodiment of the present disclosure.

### DETAILED DESCRIPTION

The systems and methods described herein relate to an electric machine with a fluid cooling system that includes air vent passages which allow air (which is mixed with oil or other coolant in the system) to be removed from cooling passages in a rotor shaft. The air vent passages extend from radial cooling passages in a rotor shaft to a cavity (which may be positioned interior to a rotor shaft bearing). The air vent passages allow the concentration of air in the system's working fluid (e.g., oil) to be reduced to increase the amount of heat that can be removed from the electric machine and increase the cooling system's pumping efficiency.

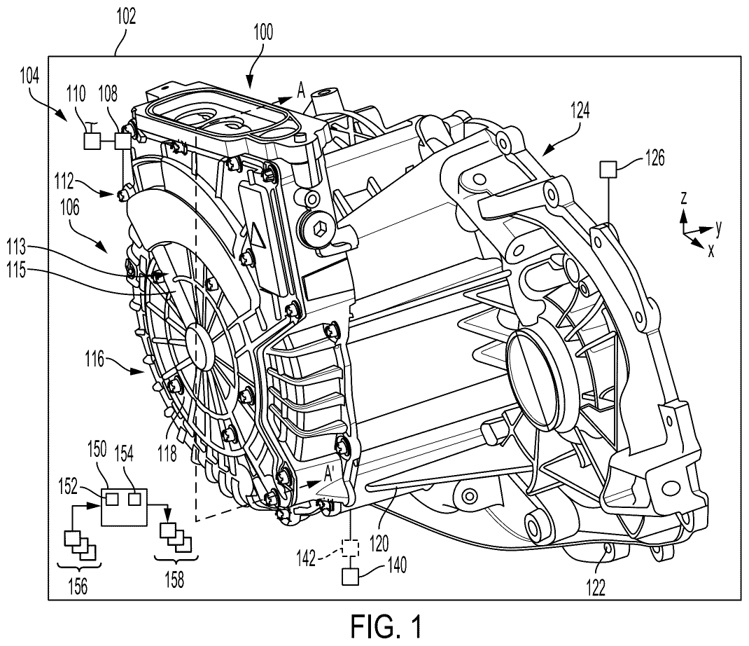

FIG. 1 shows an electric machine 100 (e.g., an electric motor, such as a motor-generator) which may be included in a system 102, such as an electric drive unit in an electric vehicle (EV). As such, the electric machine 100 may be designed to generate mechanical power, as well as electric power during a regeneration mode, in some cases. The electric drive unit may additionally include a gearbox, an inverter, and/or other suitable components, discussed in greater detail herein. In such examples, the vehicle may take a variety of forms in different embodiments, such as a light, medium, or heavy duty vehicle. Alternatively, the motor may be used in other suitable systems, such as systems in manufacturing facilities, other industrial settings, and the like. It should be appreciated that while an electric machine is herein described, the shaft fluid cooling system herein described may be applied to various other application types without departing from the scope of this disclosure, in some examples.

In some examples, in addition to the electric machine 100, the vehicle may further include another motive power source, such as an internal combustion engine (ICE) (e.g., a spark and/or compression ignition engine) or other suitable devices to generate rotational energy. The ICE may include conventional components such as cylinders, pistons, valves, a fuel delivery system, an intake system, an exhaust system, and the like. Thus, in the vehicle example, the vehicle may be an electric vehicle (EV), such as a hybrid electric vehicle (HEV) or an all-electric vehicle (e.g., battery electric vehicle (BEV)).

FIG. 1 further illustrates a fluid cooling system 104 for the electric machine 100 and specifically a rotor in the electric machine. In particular, the fluid cooling system is configured to remove heat from a rotor shaft and a lamination assembly in order to maintain rotor magnets within temperature thresholds, in some instances. The fluid cooling system 104 may include a cooling circuit 106 for cooling the electric machine. The cooling circuit 106 may be designed to circulate a working fluid, such as natural and/or synthetic oil, through the electric machine. However, another suitable working fluid may be used, in other examples.

The fluid cooling system 104 may include a filter 108 and a pump 110 (e.g., an oil pump). The pump 110 flows the working fluid to an inlet 112 of an inlet passage 113. In the illustrated example, the inlet passage 113 includes a radial section 115. However, other inlet passage contours may be used in other examples.

In one example, the pump 110 may be designed to pick up the working fluid from a sump (e.g., oil sump), which may be formed within a lower portion of a shaft housing 116. As illustrated, the pump 110 and the filter 108 may be disposed external to the shaft housing 116. However, in other examples, the pump 110 and/or the filter 108 may be incorporated in the housing. The fluid cooling system 104 may further include a heat exchanger or radiator configured to decrease the temperature of the fluid circulating through the fluid cooling system 104.

The shaft housing 116 may include sections that are removably attached to one another. To elaborate, an inlet side cover 118 may be coupled (e.g., directly coupled) to a body 120 of the shaft housing 116. The body 120 of the housing shaft 116 may further be removably coupled (e.g., directly removably coupled) to a gearbox housing 122. The gearbox housing 122 may at least partially enclose a gearbox 124 which is rotationally coupled to the electric machine 100. However, the electric machine may be coupled to another suitable component, in other examples. In turn, the gearbox 124 may be coupled to a downstream component (e.g., an axle assembly, a drive shaft, and the like). The gearbox 124 may be rotationally coupled to a downstream component 126 such as a differential, a drive shaft, and the like.

The electric machine 100 may be electrically coupled to an energy storage device 140 (e.g., a traction battery, capacitors, and the like) via an electrical interface such as a bus-bar or other suitable interface. The electric machine 100 may be a multi-phase electric machine (e.g., a three-phase machine, a six-phase machine, a nine-phase machine, etc.), in one example. In such an example, an inverter 142 may provide electrical energy to the electric machine 100 and receive electrical energy from the energy storage device 140. Multi-phase electric motors achieve greater efficiency than some direct current (DC) type motors. However, in other examples, the electric machine may be a DC electric machine.

A controller 150 may further be included in the system 102. The controller may include a processor 152 and memory 154 with instructions stored therein that, when executed by the processor, cause the controller to perform various methods and control techniques described herein. The processor may include a microprocessor unit and/or other types of circuits. The memory may include known data storage mediums, such as random access memory, read only memory, keep alive memory, combinations thereof, and the like.

The controller 150 may receive various signals from sensors 156 positioned in the system 102 and/or the electric machine 100. Conversely, the controller 150 may send control signals to various actuators 158 at different locations in the system based on the sensor signals. For instance, the controller 150 may send command signals to the pump 110, and, in response, the actuators in the pumps may be adjusted to alter the flowrate of the fluid delivered therefrom as per thermal state of the motor. In other examples, the controller may send control signals to an inverter coupled to the electric machine 100 and in response to receiving the command signals, the inverter may be adjusted to alter electric machine speed. Other controllable components in the system may be operated in a similar manner with regard to sensor signals and actuator adjustment.

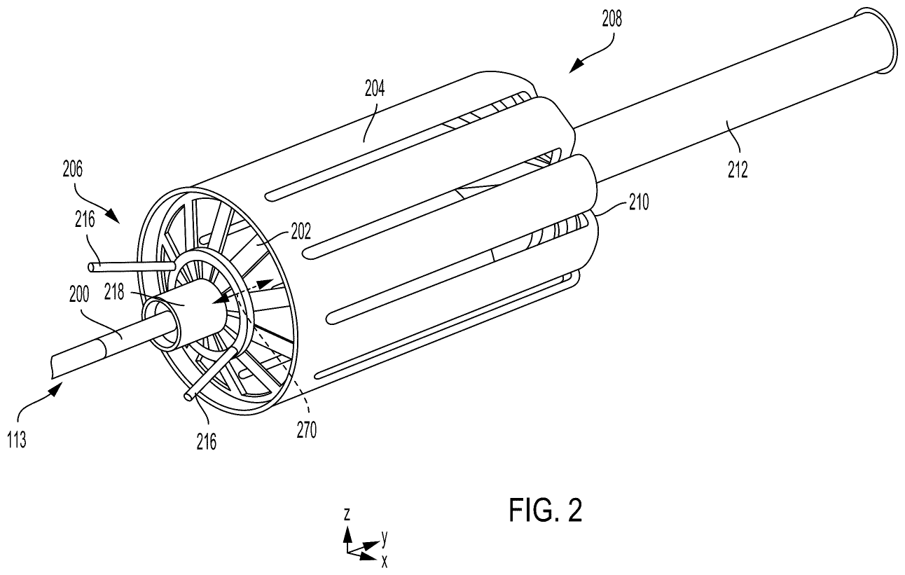

An axis system is provided in FIG. 1, as well as in FIGS. 2-8, for reference. The z-axis may be a vertical axis (e.g., parallel to a gravitational axis), the x-axis may be lateral axis (e.g., a horizontal axis), and/or the y-axis may be a longitudinal axis, in one example. However, the axes may have other orientations, in other examples.

Turning to FIG. 2, a detailed view of the fluid cooling system 104 of the electric machine 100 according to a first embodiment of the present disclosure is shown. The inlet passage 113 in the shaft housing 116 may be conceptually divided into the radial section 115 and an axial section 200.

The inlet passage 113 may further be in fluidic communication (e.g., direct fluidic communication) with radial cooling passages 202 (e.g., radial rotor shaft cooling passages). The radial cooling passages 202 may extend radially outward from the axial section 200 of the inlet passage 113. Thus, the one or more radial cooling passages 202 may be inlet side radial cooling passages. Further, the radial cooling passages 202 are angled with regard to a central axis 270 (which is the rotational axis of the electric machine during operation). The angle may be less than ninety degrees, in one example. However, in other examples, the angle may be ninety degrees.

The radial cooling passages 202 may be symmetrically distributed about the machines central axis 270 and specifically a radial plane. In this way, imbalances during rotor rotation are decreased. However, the radial cooling passages may not be equal distributed about the central axis 270, in some examples.

The fluid cooling system 104 further includes rotor shaft cooling passages 204 (e.g., outer rotor shaft cooling passages) which are in fluidic communication with the radial cooling passages 202 (e.g., inlet side radial cooling passages). The axial rotor shaft cooling passages 204 may extend through a rotor shaft to provide cooling thereto. To elaborate, each of the radial cooling passages 202 may be in fluidic communication with one of the axial rotor shaft cooling passages 204. However, in alternate examples, each radial cooling passage may be coupled to two or more rotor shaft cooling passages, or vice versa. Further, the axial rotor shaft cooling passages 204 may be positioned radially outward from the radial cooling passages 202 and may specifically be positioned close to an outer diameter of the rotor shaft. Positioning the axial rotor shaft cooling passages 204 in this manner may allow the passages to have a larger contact area for cooling due to a comparatively thin sleeve of fluid (e.g., oil) being formed in the passages, for example, to decrease flow losses in the fluid. Further, positioning the axial rotor shaft cooling passages 204 in this manner may reduce thermal resistance to rotor magnets included in the system.

The fluid cooling system 104 may be conceptually divided into an inlet side 206 and an outlet side 208. The fluid cooling system 104 may further include outlet side radial cooling passages 210, which are in fluidic communication with the axial rotor shaft cooling passages 204. The outlet side radial cooling passages 210 may be in fluidic communication with an outlet cooling passage 212. In turn, the outlet cooling passage 212 may be in fluidic communication with a downstream component, such as the gearbox 124, depicted in FIG. 1, or another suitable downstream component. The inlet side radial cooling passages 202, axial rotor shaft cooling passages 204, and outlet side radial cooling passages 210 may be incorporated into an insert 201 that is positioned within the rotor shaft.

The fluid cooling system 104 may further comprise one or more air vents 216 that are in fluidic communication with the radial cooling passages 202. The inlet and outlet side radial cooling passages 202 and 210 may be symmetric, which may reduce hydraulic loss in the shaft. In some examples, each of the one or more air vents 216 may be in fluidic communication with one of the radial cooling passages 202. Oil (and air mixed with the oil) may enter into the fluid cooling system 104, and specifically into the radial cooling passages 202, through the inlet passage 113. Via the one or more air vents 216, air may be removed from the radial cooling passages 202. The one or more air vents 216 may be angled in relation to the central axis 270. The oil may then flow through the air vents 216 towards bearings for bearing lubrication. The one or more air vents 216 may thus provide angular air venting for the system.

The air vents may have a specified diameter in relation to a diameter of the radial cooling passages to achieve desired flow dynamics. For example, diameters thereof may be selected based on size of the electric machine, the expected operating speed of the machine, and/or other factors.

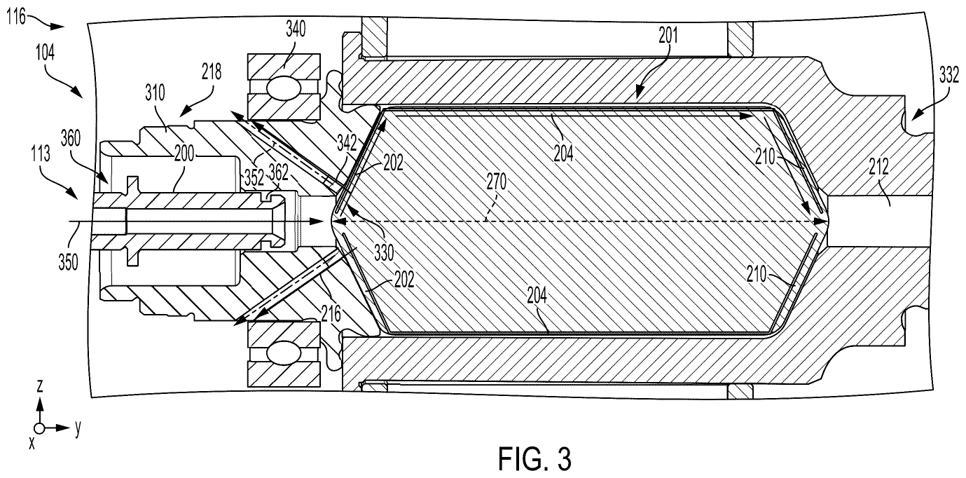

A section of the inlet passage 113 and the axial section 200 may be formed from a static insert (e.g., lance), expanded upon herein with regard to FIG. 3. An inlet section 218 of the shaft housing 116 is further shown in FIG. 2. The inlet section 218 may surround the axial section 200 of the inlet passage 113.

FIG. 3 shows a cross-sectional view of the electric machine 100 with the fluid cooling system 104 according to the first embodiment. The axial section 200 of the inlet passage 113 in the fluid cooling system 104 is depicted in FIG. 3. A static lance 360 may form a portion of the inlet passage 113. One or more seals 362 may specifically be provided at the interface between the static lance 360 and the inlet section 218 of the shaft housing 116. In some examples, the inlet section 218 may be encompassed by a shaft end cap 310 of the axial section 200 of the inlet passage 113.

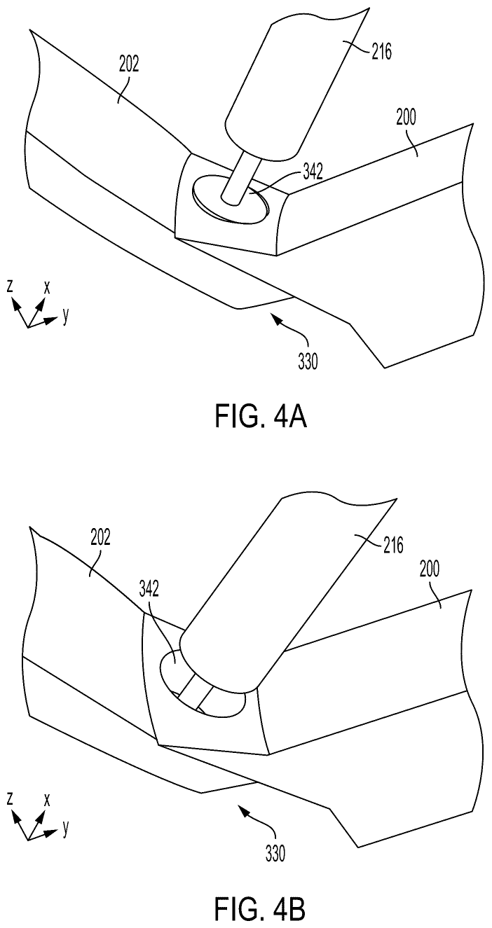

In some examples, each of the radial cooling passages 202 may be in fluidic communication through a peripherical channel 330. The peripherical channel 330 may be located close to the center of rotation of the shaft. In this way, the number of air vents may differ from the number of radial cooling passages as air may be removed from all of the radial cooling passages through a lesser number of air vents because the radial cooling passages are in fluidic communication with one another. In some examples, the one or more air vents 216 may each comprise a nozzle plug 342 between the air vent and a corresponding radial passage with which the air vent is in fluidic communication, as will be expanded upon in FIGS. 4A and 4B.

FIG. 3 further shows a rotor shaft 332. A portion of the rotor shaft 332 may extend through the shaft housing 116 as well as the gearbox housing 122 and includes an outlet (not shown) that may be in fluidic communication with cooling passages in the gearbox 124. However, other cooling system designs may be used with different fluid routing at the outlet.

Arrows 350 indicate a general direction of oil flow through the fluid cooling system 104 during operation. To elaborate, oil first flows through the inlet passage 113 to the radial cooling passages 202 (e.g., inlet side radial cooling passages), from the radial cooling passages 202 to the axial rotor shaft cooling passages 204 and into air vents 216 towards bearings 340, from the axial rotor shaft cooling passages 204 to the outlet side radial cooling passages 210, from the outlet side radial cooling passages 210 to the outlet passage 212, and from the outlet passage 212 to a downstream component such as the gearbox 124. In some examples, oil may be directed through the air vents 216 to bearings, with restrictions due to the nozzle plug 342, as will be further described.

Arrows 352 indicate a general direction of airflow through the one or more air vents 216 in the fluid cooling system 104. As previously noted, air may be mixed into the oil that enters into the fluid cooling system via the inlet passage 113. Air may flow into the air vents from the radial cooling passages 202 and may be directed towards bearings 340. The nozzle plugs 342 may restrict oil flow to the bearings 340. The arrows shown in FIG. 3 may thus represent a method for air and oil flow through the system.

Turning now to FIGS. 4A and 4B, fluid domain for the fluid cooling system 104 is shown. The nozzle plug 342 of an exemplary one of the one or more air vents 216 of the first embodiment is shown. The one or more air vents 216 may be configured so as to allow air to vent out and allow oil to be directed towards the bearings 340. In some examples, the nozzle plug 342 may be configured for partial insertion to allow for control of oil flow therethrough. In FIG. 4A, the nozzle plug 342 is positioned at a surface of the radial cooling passage 202. In FIG. 4B, the nozzle plug 342 is partially inserted into the radial cooling passage 202. When the nozzle plug 342 is positioned at the surface, oil and air may flow at the same time through the air vents 216 during filling of the rotor shaft. When the nozzle plug 342 is partially inserted into the radial cooling passage 202, air, but not oil, may flow through the air vent 216. The nozzle plug 342 may be partially inserted for air venting and may be positioned at the surface for oil flow during filling of the rotor shaft. In this way, air venting performance may be increased.

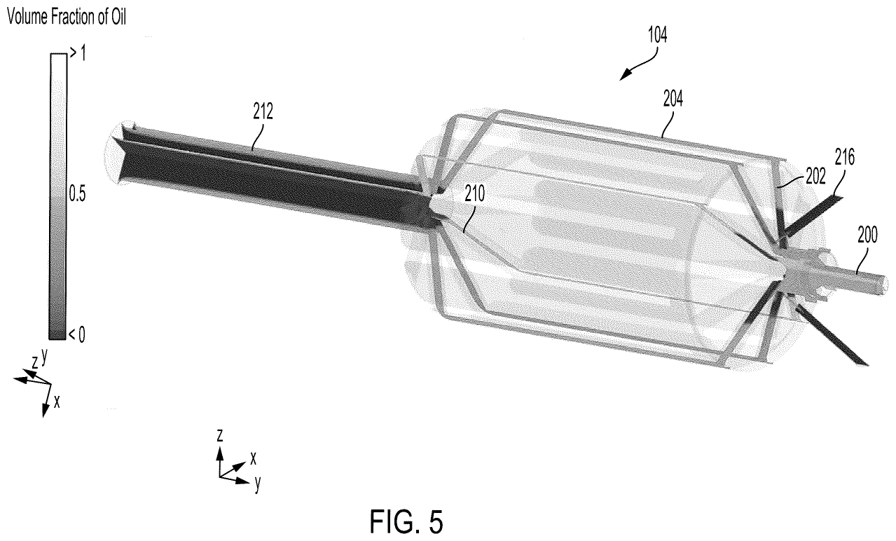

FIG. 5 shows an exemplary illustration of computational fluid dynamics (CFD) model which indicates the volume fraction of oil in the fluid cooling system 104 with regard to air. As illustrated, the system exhibits a higher fraction of oil in the passages than previous systems as a result of air venting out of the system via the one or more air vents 216. Consequently, in the fluid cooling system 104, the pressure drop and pumping power over the rotor shaft is less dependent on the speed range. Further, the fluid cooling system 104 may achieve lower pump power at higher motor speeds, when compared to fluid cooling systems with a greater amount of air in the cooling passages.

Further, in the fluid cooling system described above with regard to FIGS. 1-7, the number and size of the air vents may be selected to provide a desired amount of fluid flow to cool the back bearing of the electric machine.

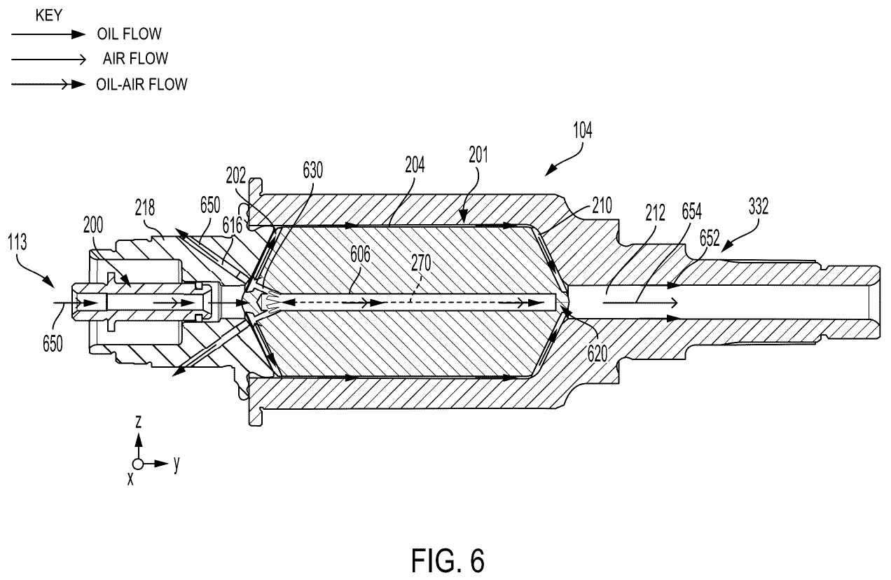

Turning now to FIG. 6, a cross-sectional view of the electric machine 100 with the fluid cooling system 104, according to a second embodiment of the present disclosure. Similar to the first embodiment described above, the fluid cooling system 104 may comprise the inlet passage 113 including the axial section 200 that is in fluidic communication with the radial cooling passages 202, the axial rotor shaft cooling passages 204, and the outlet side radial cooling passages 210. In some examples, the radial cooling passages 202 may be in fluidic communication with one or more air vents, such as the air vents 216 of the first embodiment. In other examples of the second embodiment, as shown in FIG. 6, the one or more air vents 216 may not be present. Rather, in examples without air vents, one or more oil channels 616 may direct oil towards bearings for lubrication.

In the second embodiment as herein presented, the fluid cooling system 104 comprises an air venting flow path through a central channel 606 in the shaft. The central channel 606 may be positioned within the rotor shaft 332 along the central axis 270. The central channel 606 may be in fluidic communication with the radial cooling passages 202 via radially extending sections 630. The radially extending sections 630 may be formed as part of the insert 201 along with the inlet side radial cooling passages 202, axial rotor shaft cooling passages 204, and outlet side radial cooling passages 210. The central channel 606 may be configured to vent air from the fluid cooling system 104 via the outlet. For example, the radially extending sections 630 may be hydraulically connected to the radial cooling passages 202 and originate close to the center of the radial cooling passages 202, but may be offset (e.g., not in line with) the inlet passage 113. As such, oil flow may be deflected on the nose of the shaft and may not enter the central channel 606 directly. As a result of rotor shaft rotation, centrifugal force, and differences in fluid/air density, oil may flow towards an outside of the radial cooling passages 202 and the air that may be present before filling or that may enter through inlet passage 113 along with the oil may flow towards the inner surface of the radial cooling passages 202. The trapped air may then flow through the radially extending sections 630 to the central channel 606. The central channel 606, by nature of being positioned along the central axis 270, may allow air to pass through the central channel 606 rather than the axial rotor shaft cooling passages 204, thereby decreasing pumping power demands and increasing heat transfer performance. The central channel 606 may thus allow for axial air venting of the system.

Similar to the nozzle plugs 342 of the first embodiment, in the second embodiment the fluid cooling system 104 may comprise a nozzle plug 620 that may be inserted to control fluid flow through the central channel 606, thereby minimizing the amount of oil that is leaked through the central channel.

First arrows 650 indicate a general direction of mixed oil-air flow through the one or more passages, vents, and channels in the fluid cooling system 104. Second arrows 652 indicate a general direction of oil flow through the one or more passages, vents, and channels as herein described. Third arrows 654 indicate a general direction of air flow through the one or more passages, vents, and channels as herein described. As previously noted, air may be mixed into the oil that enters into the fluid cooling system via the inlet passage 113. The mixture may flow into the central channel from the radial cooling passages 202 and may be directed towards bearings (e.g., bearings 340) and/or towards the outlet cooling passage 212. For example, oil may be directed through the one or more oil channels 616 from the radially extending sections 630 towards bearings and oil and air, separated via centrifugal forces, shaft rotation, and differences in density, may be directed towards the outlet cooling passage 212. As an example, oil may first be directed into the one or more radial passages and then into the central channel. The arrows shown in FIG. 6 may thus represent a method for air and oil flow through the system.

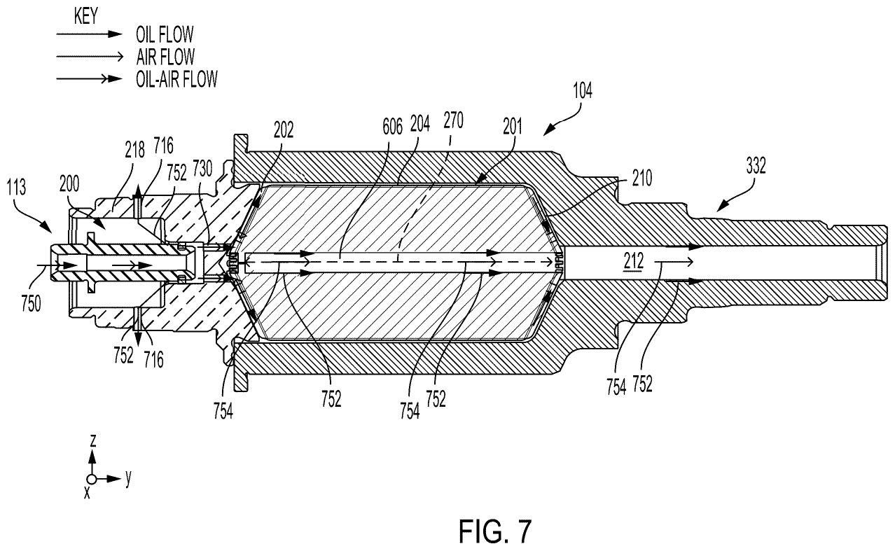

FIG. 7 shows a third embodiment of the fluid cooling system herein disclosed. In the third embodiment, similar to the second embodiment, the fluid cooling system includes a central channel. For brevity, shared components will be given the same component numbers. Similar to the first and second embodiments described above, the fluid cooling system 104 may comprise the inlet passage 113 including the axial section 200 that is in fluidic communication with the radial cooling passages 202, the axial rotor shaft cooling passages 204, and the outlet side radial cooling passages 210. The inlet passage 113 may be in fluidic communication with one or more oil channels 716. The oil channels 716 may be configured to direct oil away from the inlet passage 113 and towards bearings (not shown). The oil channels 716 may deflect oil from the inlet passage 113 rather than from the radial cooling passages 202, as is present in the second embodiment.

In the third embodiment, similar to the second embodiment, the fluid cooling system 104 comprises the central channel 606. In the third embodiment, the central channel 606 is in fluidic communication with the inlet passage 113 via channels 730. The channels 730 may be similar to the radially extending sections 630 of FIG. 6, however the channels 730 may be positioned parallel to the central axis 270 rather than angled with compared to the central axis 270. Further, the channels 730 may be formed as part of the inlet section 218 rather than as part of the insert 201. Therefore, the channels 730 may be located more towards the inlet side of the fluid cooling system 104. Thus, the insert 201 may be simpler and can be formed from a single transfer molding, reducing manufacturing complexity.

The central channel 606 of the fluid cooling system 104 according to the third embodiment herein disclosed may perform as explained with respect to the second embodiment. For example, as a result of rotor shaft rotation, centrifugal force, and differences in fluid/air density, oil may flow towards an outside of the radial cooling passages 202 and the air that may be present before filling or that may enter through inlet passage 113 along with the oil may flow towards the inner surface of the radial cooling passages 202. The trapped air may then flow through the radially extending sections 630 to the central channel 606. The central channel 606, by nature of being positioned along the central axis 270, may allow air to pass through the central channel 606 rather than the axial rotor shaft cooling passages 204, thereby decreasing pumping power demands and increasing heat transfer performance.

First arrows 750 indicate a general direction of mixed oil-air flow through the one or more passages, vents, and channels in the fluid cooling system 104. Second arrows 752 indicate a general direction of oil flow through the one or more passages, vents, and channels as herein described. Third arrows 754 indicate a general direction of air flow through the one or more passages, vents, and channels as herein described. As previously noted, air may be mixed into the oil that enters into the fluid cooling system via the inlet passage 113. The mixture may flow into the central channel from the radial cooling passages 202 and may be directed towards bearings (e.g., bearings 340) and/or towards the outlet cooling passage 212. For example, oil may be directed through the one or more oil channels 716 from the inlet passage 113 towards bearings and oil and air, separated via centrifugal forces, shaft rotation, and differences in density, may be directed towards the outlet cooling passage 212. As an example, oil may first be directed into the one or more radial passages and then into the central channel. The arrows shown in FIG. 7 may thus represent a method for air and oil flow through the system.

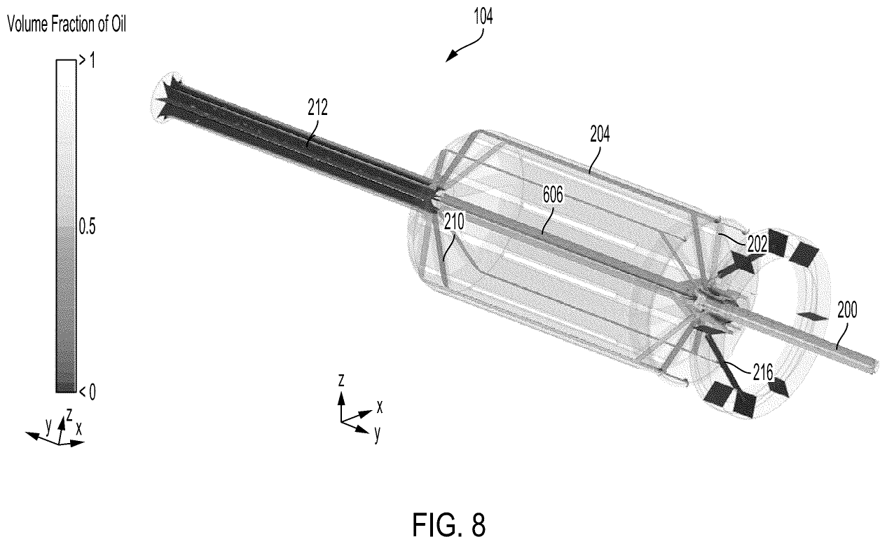

FIG. 8 shows an exemplary illustration of computational fluid dynamics (CFD) model of the oil and air in the fluid cooling system 104 according to the second embodiment presented in FIG. 6. Air is directed from the radial cooling passages 202 to the central channel 606 and from the central channel 606 to the outlet cooling passage 212. As noted, as a result of the rotation of the shaft, centrifugal force, and differences in density, air may be directed towards the central axis 270 and oil may be directed away from the central axis 270. The third embodiment of the present disclosure may result in a similar CFD model. In comparison with the first embodiment as herein described, the second and third embodiments may remove all air from the radial passages in the fluid cooling system. As a result, the centrifugal pressure may be entirely recovered and therefore the pressure drop may be independent or nearly independent from rotational speed of the shaft. Additionally, in examples in which the air vents 216 are present, air may be vented out and oil may be directed towards bearings. In examples in which the air vents 216 are not present, channels for oil flow to the bearings may be present instead. Lubrication to the bearings via oil in either example may reduce friction in the electric machine, thereby increasing machine longevity and efficiency.

FIGS. 1-8 provide for a method for a shaft fluid cooling system operation where a pump in the fluid cooling system is operated to circulate a working fluid through the radial cooling passages while air is vented through the air passages.

The technical effect of the electric machine operating method described herein is to increase fluid cooling system efficiency by removing air from the working fluid, thereby increasing electric machine efficiency. By more efficiently venting air out of the working fluid, pumping power over the shaft may be less dependent on the speed of the electric machine and lower pumping power may be demanded at higher speeds. The number and size of the air vents may be selected to provide sufficient flow to cool and lubricate the back bearing of the electric machine. Further, a central channel for air venting may remove air from the working fluid during operation of the machine. The radial cooling passages 202 may act as an air-oil separator during electric machine operation which may help to reduce hydraulic losses in shafts for a large range of motor speeds.

FIGS. 1-8 are drawn approximately to scale, aside from the schematically depicted components. However, other relative component dimensions may be used, in other embodiments.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The disclosure also provides support for a shaft fluid cooling system, comprising: one or more air vents in fluidic communication with one or more radial cooling passages, wherein the one or more radial cooling passages are in fluidic communication with: one or more rotor shaft cooling passages that extend axially through a rotor shaft, and an inlet cooling passage that extends through the rotor shaft. In a first example of the system, each of the one or more air vents is in fluidic communication with one of the one or more radial cooling passages. In a second example of the system, optionally including the first example, each of the one or more air vents comprises a nozzle plug. In a third example of the system, optionally including one or both of the first and second examples, the nozzle plug is configured to insert into one of the one or more radial cooling passages. In a fourth example of the system, optionally including one or more or each of the first through third examples, the one or more radial cooling passages comprise one or more inlet side radial cooling passages and one or more outlet side radial cooling passages, wherein the one or more inlet side radial cooling passages and the one or more outlet side radial cooling passages are symmetric. In a fifth example of the system, optionally including one or more or each of the first through fourth examples, a working fluid in one or more the radial cooling passages is mixed with air. In a sixth example of the system, optionally including one or more or each of the first through fifth examples, air is vented via one or both of angular air venting and axial air venting. In a seventh example of the system, optionally including one or more or each of the first through sixth examples for angular air venting, the one or more air vents are positioned at an inlet side of the fluid cooling system. In a eighth example of the system, optionally including one or more or each of the first through seventh examples for axial air venting, the one or more air vents are positioned along a central axis of the rotor shaft.

The disclosure also provides support for an electric machine fluid cooling system, comprising: one or more air vents in direct fluidic communication with a plurality of radial cooling passages, wherein the plurality of radial cooling passages are each in direct fluidic communication with one of a plurality of rotor shaft cooling passages and wherein each of the plurality of radial cooling passages are in direct fluidic communication with an inlet cooling passage. In a first example of the system, the plurality of radial cooling passages are equally spaced with regard to a radial plane. In a second example of the system, optionally including the first example, the electric machine is an electric motor.

The disclosure also provides support for a method for venting air from a fluid cooling system of an electric machine, comprising: directing air out of one or more radial cooling passages of the fluid cooling system and into one or more air vents. In a first example of the method, the one or more radial cooling passages are in fluidic communication with an inlet passage of the fluid cooling system, wherein a working fluid that comprises a mixture of air and oil is directed into the fluid cooling system via the inlet passage. In a second example of the method, optionally including the first example, the one or more radial cooling passages are in fluidic communication with the one or more air vents. In a third example of the method, optionally including one or both of the first and second examples, the one or more air vents are a central channel positioned along a central axis of a rotor shaft of the electric machine. In a fourth example of the method, optionally including one or more or each of the first through third examples, the method further comprises:, when the one or more air vents are the central channel positioned along the central axis, directing oil first into the one or more radial cooling passages and then into the central channel. In a fifth example of the method, optionally including one or more or each of the first through fourth examples, the one or more air vents project towards one or more bearings. In a sixth example of the method, optionally including one or more or each of the first through fifth examples, the one or more air vents each comprise a nozzle plug configured to at least partially insert into a radial cooling passage. In a seventh example of the method, optionally including one or more or each of the first through sixth examples, the nozzle plug is configured to restrict oil flow through a corresponding air vent.

Note that the example control routines included herein can be used to control various shaft fluid cooling systems. At least some of the control method steps disclosed herein may be stored as executable instructions in non-transitory memory and may be carried out by the machinery or system including the controller in combination with the various sensors, actuators, and/or other hardware in combination with the electronic controller. As such, the described actions, operations, and/or functions may graphically represent code to be programmed into non-transitory memory of the computer readable storage medium in a system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to vehicle systems that include different types of propulsion sources including different types of electric machines, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A shaft fluid cooling system, comprising:
one or more air vents in fluidic communication with one or more radial cooling passages; wherein the one or more radial cooling passages are in fluidic communication with:
one or more rotor shaft cooling passages that extend axially through a rotor shaft; and
an inlet cooling passage that extends through the rotor shaft.

2. The shaft fluid cooling system of claim 1, wherein each of the one or more air vents is in fluidic communication with one of the one or more radial cooling passages.

3. The shaft fluid cooling system of claim 1, wherein each of the one or more air vents comprises a nozzle plug.

4. The shaft fluid cooling system of claim 3, wherein the nozzle plug is configured to insert into one of the one or more radial cooling passages.

5. The shaft fluid cooling system of claim 1, wherein the one or more radial cooling passages comprise one or more inlet side radial cooling passages and one or more outlet side radial cooling passages, wherein the one or more inlet side radial cooling passages and the one or more outlet side radial cooling passages are symmetric.

6. The shaft fluid cooling system of claim 1, wherein a working fluid in one or more the radial cooling passages is mixed with air.

7. The shaft fluid cooling system of claim 1, wherein air is vented via one or both of angular air venting and axial air venting.

8. The shaft fluid cooling system of claim 7, wherein, for angular air venting, the one or more air vents are positioned at an inlet side of the fluid cooling system.

9. The shaft fluid cooling system of claim 7, wherein, for axial air venting, the one or more air vents are positioned along a central axis of the rotor shaft.

10. An electric machine fluid cooling system, comprising:
one or more air vents in direct fluidic communication with a plurality of radial cooling passages, wherein the plurality of radial cooling passages are each in direct fluidic communication with one of a plurality of rotor shaft cooling passages and wherein each of the plurality of radial cooling passages are in direct fluidic communication with an inlet cooling passage.

11. The electric machine fluid cooling system of claim 10, wherein the plurality of radial cooling passages are equally spaced with regard to a radial plane.

12. The electric machine fluid cooling system of claim 10, wherein the electric machine is an electric motor.

13. A method for venting air from a fluid cooling system of an electric machine, comprising:
directing air out of one or more radial cooling passages of the fluid cooling system and into one or more air vents.

14. The method of claim 13, wherein the one or more radial cooling passages are in fluidic communication with an inlet passage of the fluid cooling system, wherein a working fluid that comprises a mixture of air and oil is directed into the fluid cooling system via the inlet passage.

15. The method of claim 13, wherein the one or more radial cooling passages are in fluidic communication with the one or more air vents.

16. The method of claim 13, wherein the one or more air vents are a central channel positioned along a central axis of a rotor shaft of the electric machine.

17. The method of claim 16, further comprising, when the one or more air vents are the central channel positioned along the central axis, directing oil first into the one or more radial cooling passages and then into the central channel.

18. The method of claim 14, wherein the one or more air vents project towards one or more bearings.

19. The method of claim 14, wherein the one or more air vents each comprise a nozzle plug configured to at least partially insert into a radial cooling passage.

20. The method of claim 19, wherein the nozzle plug is configured to restrict oil flow through a corresponding air vent.
